(19) United States
(12) Patent Application Publication
(10) Pub. No.: US 2008/0237349 A1
(43) Pub. Date: Oct. 2, 2008

(54) Scanning Light Collection

(75) Inventors: Hakan Urey, Istanbul (TR); Randall B. Sprague, Hansville, WA (US); Serhan Isikman, Istanbul (TR)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/134,835

(22) Filed: Jun. 6, 2008

Related U.S. Application Data
(63) Continuation-in-part of application No. 11/704,695, filed on Feb. 9, 2007.
(60) Provisional application No. 60/771,586, filed on Feb. 9, 2006.

(51) Int. Cl. G06K 7/10

(52) U.S. Cl. 235/462.32

(57) ABSTRACT

A barcode scanner includes a scanning platform coupled to a fixed platform by flexible members. The scanning platform, fixed platform, and flexible members are made of a polymer such as is commonly used for printed circuit boards. The scanning platform has a laser light source, focusing lens, photodetector, and light collection optic mounted thereto. The polymer qualities and the moment of inertia of the scanning platform can be controlled to achieve a desired mechanical resonance.

### RELATED APPLICATIONS

The present application is a Continuation-in-Part (CIP) of U.S. application Ser. No. 11/704,695, entitled “Method and Apparatus for Making and Using 1D and 2D Magnetic Actuators” filed Feb. 9, 2007, which is a non-provisional application of U.S. provisional application Ser. No. 60/771,586, filed on Feb. 9, 2006, both of which are incorporated herein in their entirety by reference for all purposes.

### FIELD

The present invention relates generally to bar code scanners, and more specifically to scanning mechanisms within bar code scanners.

### BACKGROUND

Bar code scanners typically have an oscillating scanning mirror to direct a light beam over a scanning angle. Some bar code scanners also have an oscillating light collection mirror that follows the scanning angle and directs collected light to a photodetector. One such bar code scanner is shown in U.S. Pat. No. 7,204,424 awarded to Yavid et al. on Apr. 17, 2007 (the “424” patent).

The device disclosed in the 424 patent is typical of bar code scanners that employ scanning mirrors. The oscillating mirrors are kept very light with low moments of inertia to reduce the energy necessary to make the mirrors oscillate. The light beam source and photodetector circuitry are mounted to a fixed structure, and are aligned with the scanning mirror assembly.

### BRIEF DESCRIPTION OF THE DRAWINGS

FIG. 1 shows a light scanning and collection device with light emitting and light collecting systems on a scanning platform;

FIG. 2 shows a light scanning and collection device with a reflective collection optic;

FIG. 3 shows a light scanning and collection device with a transmissive collection optic;

FIG. 4 shows a cross section of a scanning platform;

FIG. 5 shows collected light on a photodiode as a function of reflection distance;

FIG. 6 shows laser light source and photodiode offsets;

FIG. 7 shows collected light power as a function of reflection distance and laser light source offsets;

FIG. 8 shows collected light power as a function of reflection distance and photodiode offset; and

FIG. 9 shows a diagram of a bar code scanning apparatus.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

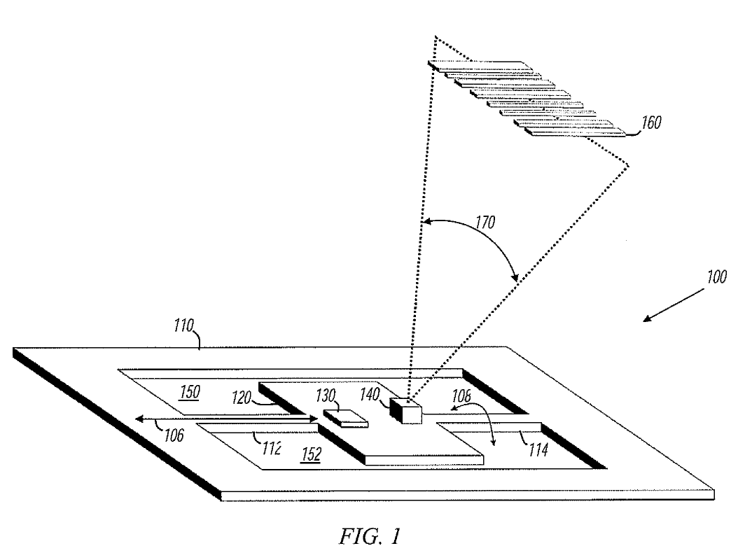

FIG. 1 shows a light scanning and collection device with light emitting and light collecting systems on a scanning platform. Device 100 includes a fixed platform 110 and a scanning platform 120. Scanning platform 120 is coupled to fixed platform 110 by at least one flexible member 112, 114. Flexible members 112 and 114 function to allow scanning platform 120 to pivot on pivot axis 106, while oscillating back and forth as shown by arrow 108. Actuating mechanisms (not shown in FIG. 1) provide the energy necessary to cause scanning platform 120 to oscillate. Various actuating mechanisms are described below with reference to later figures.

In the example embodiments represented by FIG. 1, flexible members 112 and 114 undergo a torsional flexure as scanning platform 120 pivots on pivot axis 106, although this is not a limitation of the present invention. For example, in some embodiments, flexible members 112 and 114 take on other shapes such as arcs, “S” shapes, or other serpentine shapes. The term “flexure” as used herein refers to any movement of the flexible members that allow scanning platform 120 to have an angular displacement with respect to fixed platform 110.

Scanning platform 120 includes light emitting system 140 and light collecting system 130. In some embodiments, light emitting system 140 includes a laser light source such as a laser diode or vertical cavity surface emitting laser (VCSEL). Further, in some embodiments, light emitting system 140 also includes an optical component, such as a focusing lens, to focus the laser light. Light collecting system 130 includes a light sensitive electronic device such as a photodetector or photodiode. Further, in some embodiments, light collecting system 130 also includes an optical component to collect light and direct it to the photodetector.

In operation, light emitting system 140 emits a laser light beam that is scanned across angle 170 as scanning platform 120 oscillates. The laser light is reflected off a target surface such as a barcode 160, and reflected light is collected by light collecting system 130. Mounting the light emitting and collection systems on the scanning platform adds mass to the scanning platform, and this increases the moment of inertia of the scanning assembly. The term “scanning assembly” is used herein to refer to scanning platform 120 and any objects affixed thereto.

In some embodiments, the scanning platform is made from a relatively stiff material that for a given mechanical resonant frequency accommodates a greater moment of inertia than the lightweight scanning mirrors of the prior art. For example, in some embodiments, a polymer material such as glass-epoxy material may be used. Glass-epoxy materials such as FR4 are commonly used in printed circuit board (PCB) construction.

Polymer materials may be machined to form the fixed platform, scanning platform, and flexible member(s). For example, cut-out areas 150 and 152 may be cut from a solid sheet of FR4. Cutting areas 150 and 152 from a sheet of polymer material leaves an “island” (scanning platform 120) coupled to the perimeter (fixed platform 110) by flexible members 112 and 114.

The fixed platform, scanning platform, and flexible members may have any thickness. The thickness may or may not be uniform. For example, in some embodiments, flexible members 112 and 114 may be thinner than fixed platform 110 and scanning platform 120. Thickness variations in the polymer material can be used to affect the resonant frequency of the scanning platform.

Polymer materials may also include metal layers capable of being etched during construction to form signal interconnect. For example, in some embodiments, device 100 may have copper layers on one or two sides. The copper may be etched to provide signal interconnect between the laser light source, the photodetector circuits, and other circuits (not shown). Also for example, in some embodiments, the polymer material of device 100 may be formed as a laminate structure with multiple metal layers usable for signal interconnect.

Mounting light emitting and collection systems on the scanning platform provides numerous advantages. Having most components mounted on one assembly simplifies manufacturing and alignment, and also reduces cost. Those skilled in the art will recognize many other advantages that arise from the various embodiments of the present invention.

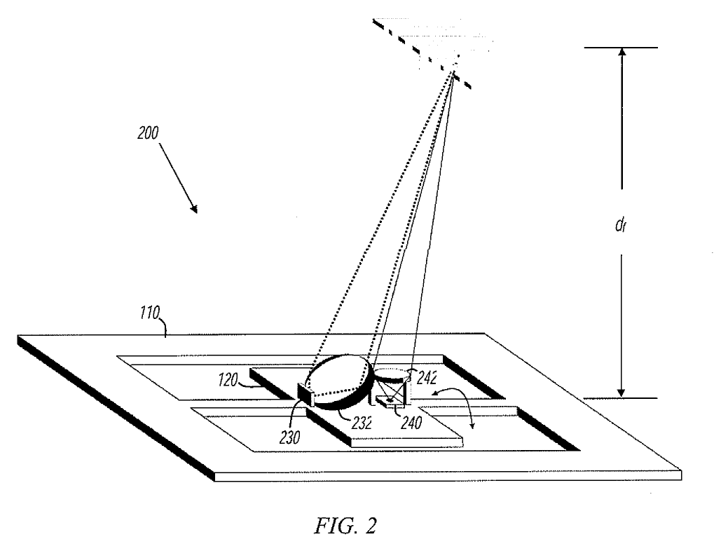

FIG. 2 shows a light scanning and collection device with a reflective collection optic. Device 200 includes fixed platform 110 and scanning platform 120 coupled by flexible members. In embodiments represented by FIG. 2, the light emitting system includes laser beam source 240 and lens 242; and the light collection system includes photodiode 230 and reflective collection optic 232. Reflective collection optic 232 collects light and reflects it to photodiode 230.

Reflective collection optic 232 is shown as a circular concave mirror, although this is not a limitation of the present invention. Any device capable of reflecting collected light may be used. Photodiode 230 is mechanically and electrically coupled to scanning platform 120. Laser beam source 240 is also electrically and mechanically mounted to scanning platform 120. Lens 242 is a focusing lens that receives laser light from source 240, and provides a converging beam away from scanning platform 120.

In operation, laser beam source 240 emits laser light, which is then focused by lens 242. The light is reflected off a surface and is then collected by optic 232 and measured by photodiode 230. The optical characteristics of lens 242 as well as the distance between lens 242 and laser beam source 240 cause the laser beam to be focused at a particular reflection distance, referred to herein as the “focused distance”, or “d_{f}”. Similarly, the optical characteristics of collection optic 232 and the distance between collection optic 232 and photodiode 230 cause the collection system to also focus at a particular reflection distance. For simplicity, the remainder of this description treats the focused distances of the light emitting system and the light collection system as being the same, although this is not a limitation of the present invention. The distance between lens 242 and scanning platform 120 also affects the moment of inertia of the scanning assembly, as does the distance between collection optic 232 and scanning platform 120.

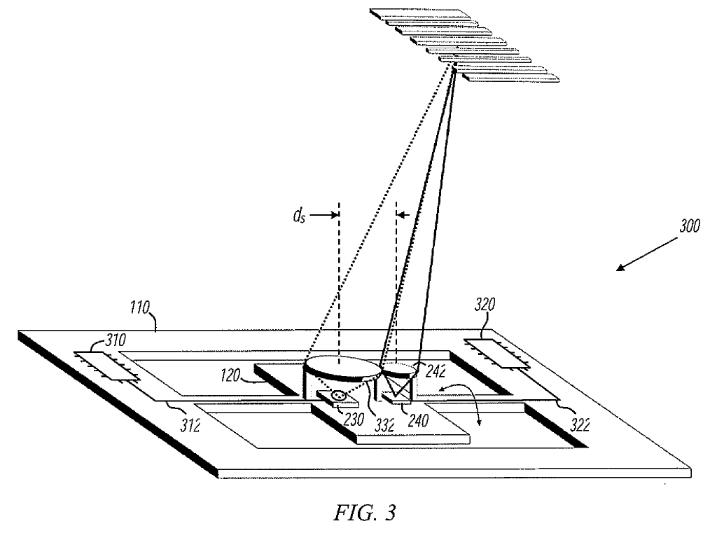

FIG. 3 shows a light scanning and collection device with a transmissive collection optic. Device 300 includes fixed platform 110 and scanning platform 120 coupled by flexible members. Similar to device 200 (FIG. 2), device 300 includes laser beam source 240, lens 242, and photodiode 230. Device 300 also includes transmissive collection optic 332, and integrated circuits 310 and 320. Transmissive collection optic 332 collects light and transmits it to photodiode 230.

Transmissive collection optic 332 is shown as a circular lens, although this is not a limitation of the present invention. Any device capable of collecting light may be used. Photodiode 230 is mechanically and electrically coupled to integrated circuit 310 by metal trace 312, and laser beam source 240 is coupled to integrated circuit 320 by metal trace 322. Integrated circuits 310 and 320 are shown as examples of devices mounted on fixed platform 110 that can be electrically coupled to the devices on scanning platform 120. In the various embodiments of the present invention, integrated circuits and other components may be mounted on the fixed platform and the scanning platform in any combination. When mounted to the scanning platform, they become part of the scanning assembly and affect the moment of inertia. When mounted to the fixed platform, they do not affect the moment of inertia of the scanning assembly.

Metal traces 312 and 314 are shown on the top surface of the polymer material, although this is not a limitation of the present invention. For example, metal traces may be on the bottom, or may be on any layer between the top and bottom. Further, any number of metal traces may be included. By utilizing a polymer suitable for use as a PCB material, electrical conductivity may be provided across the flexible members without the need for cabling or wires.

The optical centers of lens 242 and transmissive collection optic 332 are shown having a separation distance “dₛ”. This distance introduces parallax that causes a “pointing error” between the light emitting system and the light collection system. In some embodiments, the light emitting system and the light collection system are “aimed” such that they both point at the same spot at the focused distance, dₛ. For distances shorter than the focused distance, the systems lose focus and also have an aiming error introduced by the parallax. The changes in focus and aiming are advantageously used to increase the dynamic range of the photodetector as described further below.

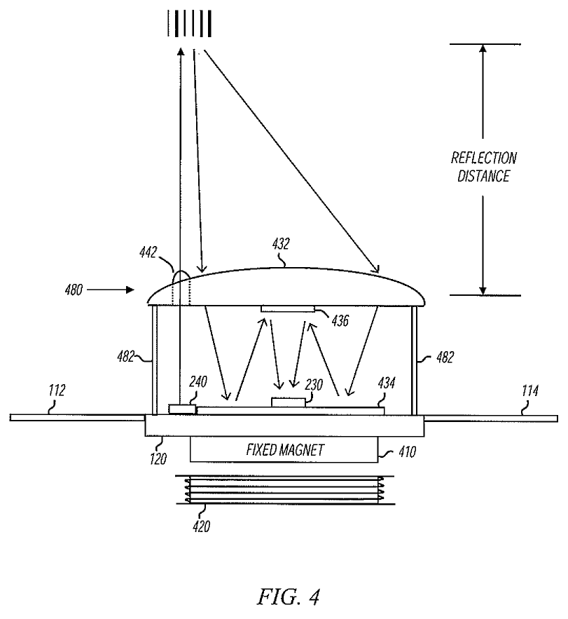

FIG. 4 shows a cross section of a scanning platform. Scanning platform 120 is shown coupled to flexible members 112, 114. Laser beam source 240, photodiode 230, and mirror 434 are shown coupled to scanning platform 120. Lens assembly 480 is also shown coupled to scanning platform by supports 482. Fixed magnet 410 is shown coupled to the underside of scanning platform 120, and electromagnet 420 is shown beneath scanning platform 120.

Electromagnet 420 and fixed magnet 410 form an actuation mechanism. In operation, electromagnet 420 is energized periodically to produce an oscillation of scanning platform 120. In some embodiments, an electromagnet is affixed to scanning platform 120, and a fixed magnet is provided beneath scanning platform 120. Other types of actuation may be provided.

Lens assembly 480 includes a focusing lens 442 formed within a transmissive collection optic 432. Lens assembly 480 also includes a mirror 436 affixed to the underside, forming a folded telescope arrangement with mirror 434. Mirror 434 is annular about photodiode 230. The distance between lens assembly 480 and scanning platform 120 affects the moment of inertia of the scanning assembly, and may be modified during the design process by varying the characteristics of the folded telescope.

In operation, laser beam source 240 produces a laser beam that is focused by focusing lens 442. The laser beam reflects off a surface and then light is collected by transmissive collection optic 432. Collected light is reflected by mirrors 434 and 436, and is then incident on photodiode 230.

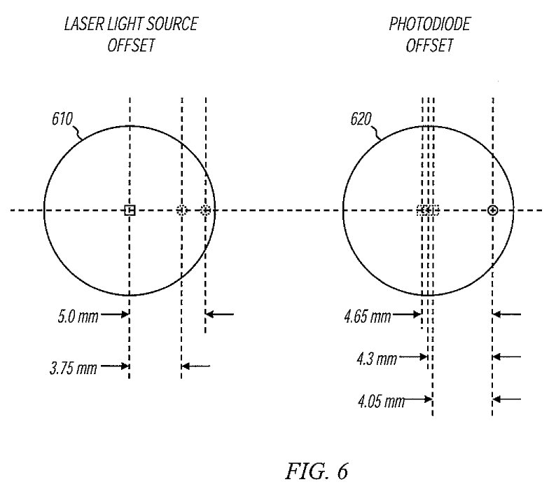

The distance between the optical centers of focusing lens 442 and transmissive collection optic 432 correspond to the separation distance dₛ described above with reference to FIG. 3. Modifying the placement of the optical centers, as well as the placement of laser beam source 240 and photodiode 230 relative to the optical centers may be used to advantage as described below with reference to FIGS. 6-8.

In some embodiments, the light emitting system and the light collection system are aimed to point to one spot at a particular reflection distance as described above with reference to FIG. 3. In other embodiments, the light emitting system and the light collection system are aimed parallel, effectively aiming out to infinity. In these embodiments, the focused distance is great enough to approximate infinity.

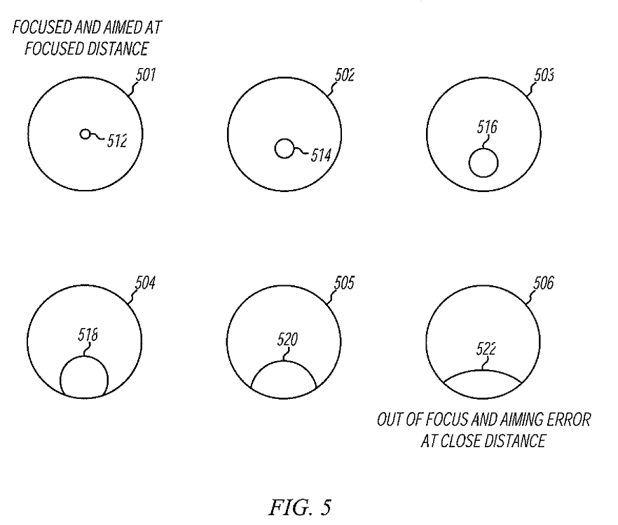

FIG. 5 shows collected light on a photodiode as a function of reflection distance. The outer circles represent the outline of the photodiode, and the inner circle/shapes “spots” represent incident reflected and collected energy. The circles numbered from 501 to 506 represent decreasing reflection distances. As the reflection distance decreases, the spot goes out of focus (gets bigger), and because of parallax the spot starts to move off the photodiode. These two phenomena reduce the efficiency of the light collection. Reduced collection efficiency allows the system to operate at smaller reflection distances that might otherwise saturate the photodiode.

At 501, circle 512 represents the collected light that has been reflected from the focused distance, d_{f}. At 502, the reflection distance is somewhat less than the focused distance. As a result, the spot is slightly defocused, therefore becoming larger. Because of parallax, the spot is also moving away from the center. At 503, the spot 516 is still larger and has moved further from the center. At 504, the spot 518 is still larger, but has started to move off the photodiode. At 505, the spot 520 has moved further off the photodiode, and at 506, the spot 522 has moved significantly off the photodiode.

The shape of circles 501-506 may represent a “mask” that is affixed to the photodiode. For example, the circle shown on photodiode 230 in FIG. 3 represents a mask. The mask may be any shape, including circular, square, elliptical, or any other shape.

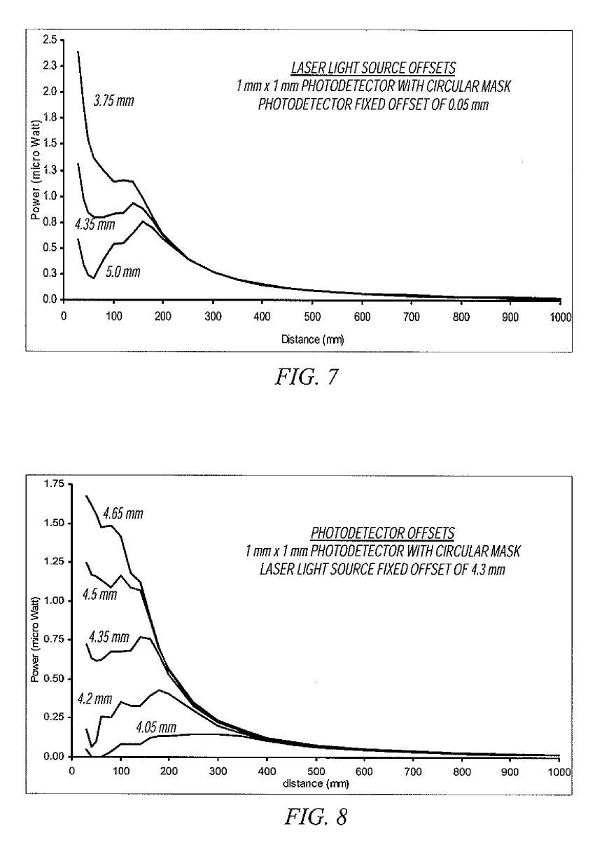

FIG. 6 shows laser light source and photodiode offsets. The circles shown in FIG. 6 represent the outline of a top view of lens assembly 480 (FIG. 4). At 610, various light source offsets are shown, and at 620, various photodiode offsets are shown. The experimental effects of these offsets are shown in the graphs of FIGS. 7 and 8.

FIG. 7 shows collected light power as a function of reflection distance and laser light source offsets. The collected power plots of FIG. 7 are parameterized using three laser offsets, two of which are shown at 610 of FIG. 6. The data shown in FIG. 7 was taken with the photodiode having a 0.05 mm fixed horizontal offset. The focused distance is designed to be one meter (1000 mm) in the experimental system. As the reflection distance decreases, the collected power goes up until the parallax causes the defocused spot (FIG. 5) to fall off the edge of the photodiode. As shown in FIG. 7, increased laser light source offsets result in reduced collected power at shorter reflection distances.

FIG. 8 shows collected light power as a function of reflection distance and photodiode offset. The collected power plots of FIG. 8 are parameterized using five photodiode offsets, two of which are shown at 620 of FIG. 6. The laser beam source is a constant distance (4.3 mm) from the optical center of the collection lens, and the location of the photodiode is varied. Similar to the effects shown in FIG. 7, as the reflection distance decreases, the collected power goes up until the parallax causes the defocused spot (FIG. 5) to fall off the edge of the photodiode.

As shown in FIGS. 7 and 8, a perfectly focused and aimed optical system without offsets (zero separation distance) will result in collected power that varies inversely with the square of the reflection distance. With the offsets, the parallax operates to compensate for the increased collection power at short reflection distances by reducing collection efficiency. This extends the available dynamic range of the optical systems to cover a wider range of reflection distances.

During the design of the optical system, the collection optic is focused and aimed such that at the farthest desired reflection distance, the laser spot will be best focused and centered on the photodiode. Then the separation distance is set such that the defocus and spot movement off the photodiode provide compensation for the exponential power increase at shorter reflection distances. The mechanical design process is integrated with the optical design process in order to produce a scanning assembly with the desired mechanical resonant characteristics for scanning.

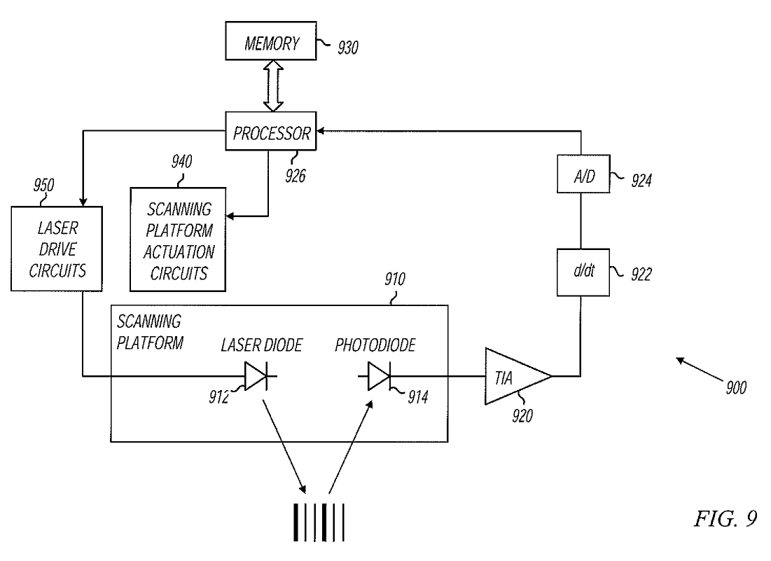

FIG. 9 shows a diagram of a bar code scanning apparatus. Apparatus 900 includes scanning platform 910, laser diode 912, photodiode 914, transimpedance amplifier (TIA) 920, differentiator 922, analog-to-digital (A/D) converter 924, processor 926, memory 930, laser drive circuits 950, and scanning platform actuation circuits 940.

Scanning platform 910 may be any scanning platform embodiment described herein. For example, scanning platform 910 may be scanning platform 120, and may include reflective and/or transmissive optics. Scanning platform 910 is shown having laser diode 912 and photodiode 914. Laser diode 912 is driven by laser drive circuits 950. Laser drive circuits 950 provide the current drive necessary to cause laser diode 912 to produce laser light.

Photodiode 914 receives reflected laser light, and provides a current representing the received light power. The current from the photodiode is provided to TIA 920, which converts the current to a voltage. TIA 920 drives a differentiator 922, which detects changes in received light power as the laser beam is scanned. A/D 924 converts the output of differentiator 922 to a digital representation, and provides it to processor 926.

Processor 926 represents any type processing apparatus. For example, processor 926 may be a microprocessor, digital signal processor (DSP), microcontroller, or the like. Also for example, processor 926 may be a dedicated hardware circuit, such as a state machine. Memory 930 is coupled to processor 926. Memory 930 may be any type of apparatus capable of storing information. For example, memory 930 may be volatile memory such as static random access memory (SRAM) or dynamic random access memory (DRAM). Also for example, memory 930 may be nonvolatile memory such as “Flash” memory. Still further, memory 930 may be a computer readable medium that is encoded with instructions to be executed by processor 926. Examples of computer-readable media include, but are not limited to, floppy disks, hard disks, CD-ROM, or any other suitable storage device.

Scanning platform actuation circuits 940 provide excitation to scanning platform 910 to cause mechanical oscillation. Actuation circuits 940 may include any type of circuits capable of producing the mechanical forces, including magnetic, thermal, and electrostatic circuits.

Bar code scanning apparatus 900 may be handheld or stationary. In addition, bar code scanning apparatus 900 may include many other components. For example, bar code scanning apparatus 900 may include a display, a “trigger” device to enable a user to initiate scanning, data communications ports, radio frequency (RF) transceivers such as Bluetooth or Ultra Wideband (UWB), speakers, haptic feedback devices, or the like.

The various embodiments of the invention as described represent a highly integrated system that combines mechanical (static and dynamic), electrical, and optical systems into one assembly. A single scanning assembly can include a laser light source, a photodetector, associated optics, and electronic components. The size, weight, and location of components can be modified, all of which can affect the moment of inertia. Components can also be mounted varying distances away from the scanning platform to affect the moment of inertia. For example, lenses can be mounted at varying heights above the pivot axis of the scanning platform. The thickness of the polymer substrate can also be varied. All of the variables available to the designer may be manipulated to arrive at an optical system with increased range as well as a mechanical system with the desired resonant qualities for a scanning light emitting and collection system.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising:
a fixed platform;
at least one flexible member coupled to the fixed platform;
a scanning platform coupled to the at least one flexible member;
an actuating mechanism to produce an angular displacement between the scanning platform and the fixed platform; and
a laser light source mounted to the scanning platform to project laser light in different directions based on the angular displacement between the scanning platform and the fixed platform.

2. The apparatus of claim 1 wherein the actuating mechanism includes a first magnetic actuator coupled to the scanning platform and a second magnetic actuator coupled to the fixed platform.

3. The apparatus of claim 1 further comprising an optically transmissive light collection device mounted to the scanning platform.

4. The apparatus of claim 3 further comprising a light sensitive electronic device mounted to the scanning platform.

5. The apparatus of claim 1 further comprising an optically reflective light collection device mounted to the scanning platform.

6. The apparatus of claim 5 further comprising a light sensitive electronic device mounted to the scanning platform.

7. The apparatus of claim 1 further comprising a lens mounted to the fixed platform, the lens to focus the laser light from the laser light source.

8. The apparatus of claim 1 wherein the fixed platform, scanning platform, and at least one flexible member comprise a polymer material.

9. An apparatus comprising:
a fixed platform;
a scanning platform movable with respect to the fixed platform;
at least one flexible member coupling the scanning platform to the fixed platform, an axis of the at least one flexible member forming a pivot axis;
means for creating movement of the scanning platform on the pivot axis; and
a photodiode mounted to the scanning platform.

10. The apparatus of claim 9 wherein the at least one flexible member includes at least one metal trace to provide electrical connectivity to the photodiode.

11. The apparatus of claim 9 wherein the fixed platform, scanning platform, and at least one flexible member are constructed from an epoxy-fiberglass material.

12. The apparatus of claim 9 further comprising a laser light source mounted to the scanning platform, the laser light source aligned to produce a laser spot beam that moves as the scanning platform moves.

13. The apparatus of claim 12 further comprising an optical collection device coupled to the scanning platform, the optical collection device being aimed and focused to collect scattered light from at least one surface illuminated by the laser light source.

14. The apparatus of claim 13 wherein the laser light source and the optical collection device are mounted a separation distance from each other along the pivot axis.

15. The apparatus of claim 14 wherein the separation distance is set such that collected light moves away from the photodiode as the laser spot beam is reflected from objects progressively closer.

16. A bar code reader apparatus comprising:
a substrate having at least one cut-out area to form an island coupled to at least one flexible member, an axis of the at least one flexible member forming a pivot axis;
a laser light emitting component mounted to the island on the pivot axis; and
an optical collection device mounted to the island on the pivot axis.

17. The bar code reader apparatus of claim 16 wherein the optical collection device comprises an optically transmissive device.

18. The bar code reader apparatus of claim 17 further comprising a photodiode mounted to the island and aligned to receive light collected from the optically transmissive device.

19. The bar code reader apparatus of claim 16 wherein the optical collection device is aimed and focused to collect maximum laser light reflected from a focused reflection distance.

20. The bar code reader apparatus of claim 19 wherein the optical collection device is spaced from the laser light emitting component resulting in parallax to create an aiming error as laser light is reflected from progressively shorter distances.

21. A light beam scanning and collection apparatus comprising:
a laser light source to create a laser spot beam;
a light sensitive electronic component to sense laser light from the laser spot beam after having been reflected;
a scanning platform upon which the laser light source and light sensitive electronic component are mounted; and
an actuator device coupled to the scanning platform to cause the scanning platform to scan in at least one dimension.

22. The light beam scanning and collection apparatus of claim 21 wherein the scanning platform comprises a polymer material.

23. The light beam scanning and collection apparatus of claim 22 further comprising:
a fixed platform; and
at least one flexible member formed between the fixed platform and the scanning platform.

24. The light beam scanning and collection apparatus of claim 23 further comprising a second actuator device coupled to the fixed platform to magnetically interact with the actuator device coupled to the scanning platform.

25. The light beam scanning and collection apparatus of claim 21 wherein the laser light source and the light sensitive electronic device are mounted on a pivot axis of the scanning platform.
